(19) United States
(12) Patent Application Publication
(10) Pub. No.: US 2026/0080499 A1
(43) Pub. Date: Mar. 19, 2026

(54) SCALABLE INTERRUPT HANDLING USING A TUNNEL CONTROLLER

(71) Applicant: QUALCOMM Incorporated, San Diego, CA (US)

(72) Inventors: Mei Yang, San Diego, CA (US); Rohan Desai, San Diego, CA (US); Zhen Liu, San Diego, CA (US)

(21) Appl. No.: 18/890,515

(22) Filed: Sep. 19, 2024

(51) Int. Cl. G06T 1/60; H04N 23/80

(52) U.S. Cl. CPC G06T 1/60; H04N 23/80

(57) ABSTRACT

This disclosure provides systems, methods, and devices for image signal processing that support scalable, low latency interrupt handling. In a first aspect, a method of image processing includes receiving, by a controller, an interrupt notification based on a data write into a portion of a memory; determining, by the controller and based on the interrupt notification, a fill level associated with the portion of the memory; and transferring, by the controller and based on the fill level satisfying a threshold level associated with a processor, data associated with the data write to the processor. Other aspects and features are also claimed and described.

### TECHNICAL FIELD

Aspects of the present disclosure relate generally to image processing, and more particularly, to high frequency, low latency, methods and devices for image processing.

### INTRODUCTION

Image capture devices are devices that can capture one or more digital images, whether still images for photos or sequences of images for videos, and may be used for virtual reality (VR), augmented reality (AR), and/or mixed reality (XR) platforms. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, mixed reality devices and/or headsets, with digital imaging or video capabilities.

The amount of image data captured by an image sensor has increased through subsequent generations of image capture devices. The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display (e.g., on a mixed reality (XR) system or device). Such enhancements and processing can cause latency. In particular, for mixed reality experiences, such as those utilizing Video See Through (VST), user experience may be affected by photon to photon (P2P) latency, which is the delay between a change in the real-world scene affecting the see-through video appearing in the mixed reality headset.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Low latency image processing, such as used for video see through (VST) and other mixed reality applications, may involve processing image data at higher frequencies and at finer granularities. Such operations may involve a division of images into smaller slices (e.g., chunks). Conventionally, the availability of a slice results in a trigger to a processor in the pipeline to process the slice. Such triggers result in a large number of interrupts for processing each image frame. In some systems, the total number of interrupts, which includes the image slice processing interrupts and other interrupts, to handle per second in mixed reality systems is large (e.g., more than about 7.2 k interrupts per second). Handling such a large number of interrupts increases latency. Various embodiments of the present disclosure address one or more of the described shortcomings by reducing the number of interrupts and/or reducing the latency for handling interrupts.

In some aspects, image frames captured by a camera are divided into image slices for processing. The data write of each image slice into a memory may trigger an interrupt notification to the core processors responsible for the further processing. As previously discussed, the large number of interrupts that are typically handled by downstream processors in the pipeline of image processing (e.g., consumer cores, image post processing engines (IPE), etc.) cause latency in mixed reality platforms, thus negatively impacting the user experience. However, various embodiments of the present disclosure describe a tunnel controller to offload the interrupt handling from such processors, which reduces latency in handling interrupts and allows such processors to perform other functions. The tunnel controller may monitor the fill level of the portion of the memory storing image slices associated with a specific image context (e.g., image frame, image data stream, image sender or source, etc.). The fill level may depend or vary based on the number or extent of image slices being written into, or ready from, the memory. The tunnel controller may compare the fill level of the memory to a threshold level that is specific to the processor (e.g., IPE, consumer core, etc.) configured to further process the image slices stored in the said portion of the memory. If the fill level satisfies the threshold level of the processor, the tunnel controller may transfer or cause the transfer of the image slices to the processor for further processing, such as by triggering an interrupt to the processor to begin processing the image slices or triggering an interrupt to another component that causes the processor to begin processing the image slices.

In one aspect of the disclosure, a method for image processing includes: receiving, by a controller, an interrupt notification based on a data write into a portion of a memory; determining, by the controller and based on the interrupt notification, a fill level associated with the portion of the memory; and transferring, by the controller and based on the fill level satisfying a threshold level associated with a processor, data associated with the data write to the processor.

In an additional aspect of the disclosure, an apparatus includes at least one processor and a memory coupled to the at least one processor. The at least one processor is configured to perform operations including receiving an interrupt notification based on a data write into a portion of the memory; determining, based on the interrupt notification, a fill level associated with the portion of the memory; and transferring, based on the fill level satisfying a threshold level associated with a second processor, data associated with the data write to the second processor.

In an additional aspect of the disclosure, an apparatus includes means for receiving an interrupt notification based on a data write into a portion of the memory; determining, based on the interrupt notification, a fill level associated with the portion of the memory; and transferring, based on the fill level satisfying a threshold level associated with a second processor, data associated with the data write to the second processor.

In an additional aspect of the disclosure, a non-transitory computer-readable medium stores instructions that, when executed by a processor, cause the processor to perform operations. The operations include: receiving an interrupt notification based on a data write into a portion of the memory; determining, based on the interrupt notification, a fill level associated with the portion of the memory; and transferring, based on the fill level satisfying a threshold level associated with a second processor, data associated with the data write to the second processor.

In an additional aspect of the disclosure, an image capture device is disclosed that comprises a camera, a front end processor, an image processing engine (IPE), a memory, and a controller. The camera may be configured to capture an image. The front end processor may be configured to generate a plurality of slices of image data from the image. The IPE may be configured to perform image processing on the plurality of slices of image data. The memory may be configured to memory configured to store the plurality of slices of image data. The controller coupled to the memory and configured to perform operations comprising: receiving an interrupt notification based on a data write of a slice of data into a queue of the memory; determining, based on the interrupt notification, queue information for the slice of data and a fill level associated with the queue of the memory, wherein fill level is determined using the queue information; sending, based on the fill level satisfying a threshold level associated with the image post-processing engine (IPE), the interrupt notification to the IPE to process the slice of image data; and transferring the slice of data to the IPE.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 4A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same fields of view. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 is a block diagram illustrating an example data flow path for image processing to achieve scalable, low latency interrupt handling, according to some embodiments of the disclosure.

FIG. 4A is a block diagram illustrating an example data flow path for image processing to achieve scalable, low latency interrupt handling using an inter-processor communications controller (IPCC), according to some embodiments of the disclosure.

FIG. 4B is a block diagram illustrating an example data flow path for image processing to achieve scalable, low latency interrupt handling, using a direct link between the image front end (IFE) and a tunnel controller, according to some embodiments of the disclosure.

FIG. 4C is a block diagram illustrating an example data flow path for image processing to achieve scalable, low latency interrupt handling using an interval-based interrupt handling, according to some embodiments of the disclosure.

FIG. 5 shows a flow chart of an example method for processing image data with to achieve scalable, low latency interrupt handling, according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including scalable techniques for reducing latency associated with interrupt handling, for example, in mixed reality systems and devices. In various aspects, a hardware block, referred to herein as a “tunnel controller,” is used to offload interrupt handling typically performed by back end processors (also referred to herein as “core processors” or “cores”) of mixed reality systems and devices. The tunnel controller may handle interrupts by monitoring the fill levels in queues (or other data structures or portions of the memory) storing slices of an image data (also referred to herein as “image slices” “chunks” or “image slice data”). The fill levels may be compared to thresholds associated with the processor cores downstream in the image processing pipeline (e.g., IPE and other related consumer cores). If the fill level of a given queue satisfies a threshold level, the tunnel controller may facilitate the transfer of the image slice in the given queue to the IPE and other consumer cores for further processing. By alleviating interrupt handling, the IPE and other consumer cores core processors can perform further processing of the image data more efficiently, thereby providing a low latency user experience. Although various embodiments of the present disclosure may refer to the IPE as an example of the downstream processor for which a threshold level is determined and from which interrupt handling is offset via the tunnel controller, it is contemplated that embodiments described herein may similarly apply to other consumer cores and/or other down stream processors. Furthermore, various embodiments of the present disclosure describe the tunnel controller configured to monitor fill levels associated with multiple queues (or multiple portions of the memory), which may be respectively associated with multiple IFEs, image sources or senders (e.g., multiple cameras and/or sensors). Hence, the ability to monitor multiple queues allows the tunnel controller to easily scale interrupt handling for image processing associated with multiple cameras or sensors.

Particular implementations of the subject matter described in this disclosure may be implemented to realize one or more of the following potential advantages or benefits. In some aspects, the present disclosure provides techniques for scalable, low latency interrupt handling, for example, in mixed reality systems and devices. In the application of video see through (VST) operation, the reduced latency improves the user experience by allowing the user to see on the display the real-time events occurring in the real-world around the user. More generally, reduced latency in processing images improves the smoothness of a video displayed to a user. The smoother video reduces user headache when viewing the video and results in the video appearing more realistic.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as those on a smartphone, an automobile, an AR/VR device or headset, etc., may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The ISPs further include a tunnel controller configured to offset interrupt handling, as will be described herein in more detail. The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

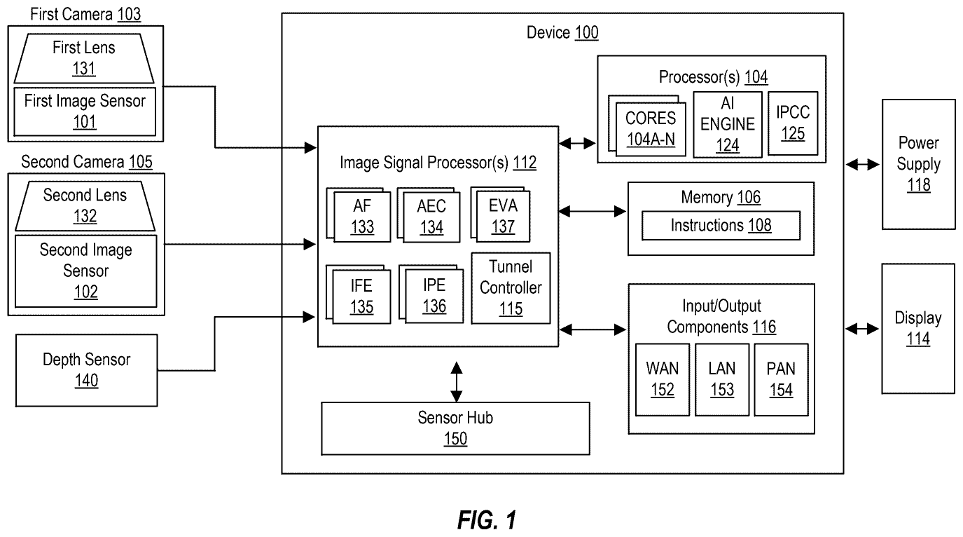

FIG. 1 shows a block diagram of a device 100 for performing image capture from one or more image sensors. The device 100 may include, or otherwise be coupled to one or more image signal processors (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). In some embodiments, the memory 106 may include a double data rate (DDR) memory (e.g., a Double Data Rate Synchronous Dynamic Random-Access Memory (DDR-SDRAM) memory). As will be described in more detail herein, the memory may be configured for the data write and/or the data read of image data. For example, portions or chunks of the image data (e.g., image slices) that may be related by context may be stored in portions of the memory 106 (e.g., in queues or other related data structures). The device 100 may also include or be coupled to a display 114 and components 116. Components 116 may be used for interacting with a user, such as a touch screen interface and/or physical buttons. In some embodiments, the display 114 may be configured to provide a mixed reality (e.g., an augmented reality) experience.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mm Wave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135) (also referred to herein as “front end processor”), a tunnel controller 115, image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, tunnel controller 115, IPE 136, and/or EVA 137. In some embodiments, the image pipeline may be reconfigurable in the ISP 112 by changing connections between the IFE 135, tunnel controller 115, IPE 136, and/or EVA 137. For example, the tunnel controller 115 may be offset interrupt handling from the IPE 136. In some embodiments, the image pipeline may involve one or more processor 104 components, such as IPCC 125, as will be discussed herein. The AF 133, AEC 134, IFE 135, tunnel controller 115, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames, or slices of image frames (image slices). The image frames or image slices may be output image frames or output image slices stored by the ISP 112. The output image frames or output image slices may be accessed by the processor 104 for further operations. For example, in some embodiments, an inter-processor communication controller (IPCC) 125 may access image slices, image frames, or stored queue information about the image slices or image frames. In some embodiments, the device 100 does not include the memory 106. For example, the device 100 may be a circuit including the ISP 112, and the memory may be outside the device 100. The device 100 may be coupled to an external memory and configured to access the memory for writing output image frames or output image slices for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including scalable methods of low latency interrupt handling described herein. For example, execution of the instructions can instruct the ISP 112 to begin or end capturing an image frame or a sequence of image frames, in which the capture includes correction and interrupt handling as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence. Furthermore, the tunnel controller 115 may access information about stored image slices or image frames from the memory 106 to offset interrupt handling from the IPE 135 and other consumer cores and/or downstream processors, according to techniques described herein.

In some embodiments, the processor(s) 104 may include ICs or other hardware (e.g., an artificial intelligence (AI) engine such as AI engine 124 or other co-processor) to further offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some embodiments, the processor(s) 104 may include an inter-processor communication controller (IPCC) 125. The IPCC 125 may be used to interface between the memory 106, ISP(s) 112, and the tunnel controller 115. In some embodiments, the IPCC 125 may comprise a system on a chip centralized processor (SOC-CP) configured to perform such interfacing. For example, the IPCC may include hardware configured to facilitate the storage of image data (e.g., image slices or image frames), update queue information associated with the data write of the image data, and provide tokens or queue information to the tunnel controller 115 for interrupt handling. In some other embodiments, the device 100 does not include one or more of the processor(s) 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. In some embodiments, the display 114 may be configured to facilitate an augmented or mixed reality experience, for example, using transparency, semi-transparency, or video see through (VST) technology. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor(s) 104, components (such as the processor(s) 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

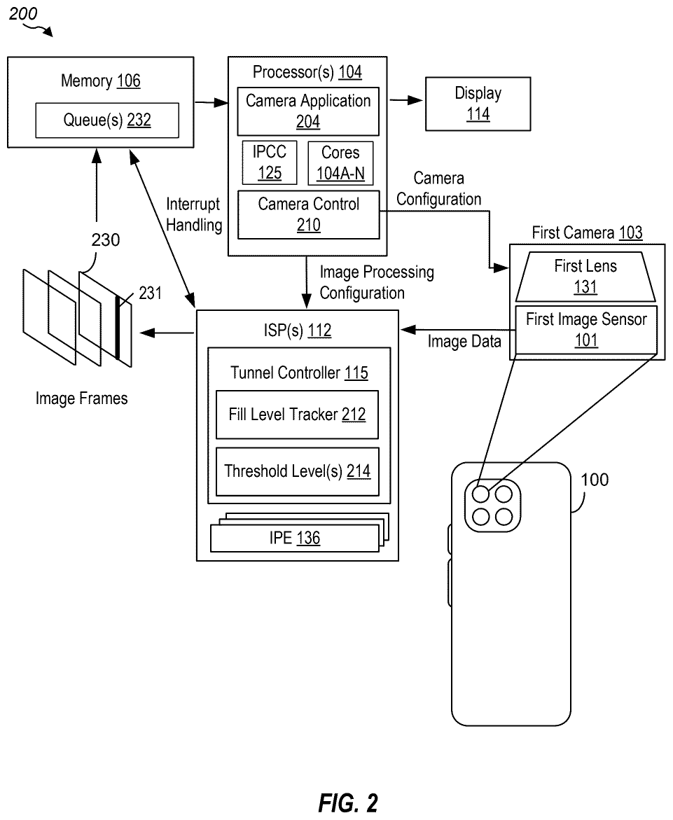

FIG. 2 is a block diagram illustrating an example data flow path for image data processing in an image capture device according to one or more embodiments of the disclosures. Processor(s) 104 of system 200 may communicate with ISP(s) 112 through a bi-directional bus and/or separate control and data lines. The processor(s) 104 may control the first camera 103 through camera control 210. The camera control 210 may be a camera driver executed by the processor(s) 104 for configuring the first camera 103, such as to active or deactivate image capture, configure exposure settings, and/or configure aperture size. Camera control 210 may be managed by a camera application 204 executing on the processor(s) 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor(s) 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor(s) 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP(s) 112 to determine output image frames 230 or output image slices 231 that may be stored in memory 106 and/or otherwise provided to the processor(s) 104. The processor(s) 104 may further process the image data to apply effects to the output image frames 230. Effects may include Bokeh, lighting, color casting, and/or high dynamic range (HDR) merging. In some embodiments, the effects may be applied in the ISP(s) 112. In some embodiments, one or more processors 104, such as IPCC 312, may facilitate the data write of the output image slices 231 into the memory 106, and may facilitate the retrieval of storage information pertaining to the output image slices 231 (e.g., queue information) for interrupt handling by the tunnel controller 115.

The output image frames 230 and slices 231 by the ISP 112 may include representations of the scene improved by aspects of this disclosure. Such improvements may include but are not limited to increased image resolution through image slicing, latency reduction by offsetting interrupt handling resulting from the processing of image slices 231, and scalability of such improvements through context-specific interrupt handling. The IPE may further process output image slices and/or frames, and the processor 104 may display these output image frames 230 to a user, with minimal latency, through use of the tunnel controller 115 of the ISP 112. For example, the tunnel controller 115 in the ISP 112 may receive an interrupt notification when an image slice 231 is written into the memory 106. The tunnel controller 115 may use the interrupt notification to receive or otherwise access queue information from the memory 106. The queue information may indicate the number of, size of, or extent of, image slice data written into (e.g., dumped into) a queue (or other portion) of the memory 106 or read from (e.g., accessed from) the queue, for a given context, such as a given image frame, image data stream, image source (e.g., camera or sensor), etc. For example, portions of image data (e.g., image slices) may be written into queues in the memory 106, where such queues may respectively correspond to these contexts. That is, each queue may be dedicated to a specific context (e.g., an image frame, an image data stream, or an image source (e.g., a camera or sensor).

The tunnel controller 115 may use the queue information to determine a fill level for the associated queue. In some embodiments, the tunnel controller 115 may update an internal fill level tracker 212 to determine the fill level. The fill level tracker 212 may be a software module, program, or code configured to internally track a fill level associated with a queue 232 and/or other portion of the memory 106 (e.g., based on the retrieved queue information). In some embodiments, a fill level may indicate the extent to which image slices pertaining to a given context (e.g., a given image frame, image data stream, image source) is completed. Also or alternatively, the fill level may indicate the capacity utilization of a queue based on the current image slices stored.

For each context, the tunnel controller 115 may compare the fill level with a threshold level of an IPE 136 and/or other consumer core (core-specific threshold level 214). In some embodiments, each IPE 136 may be designated, assigned, or configured to post-process and/or perform downstream processing of the output image slices pertaining to the context. Also or alternatively, IPEs 136 may be configured to or assigned to process or display the image data for multiple contexts. The core-specific threshold level 214 may indicate a threshold fill level at which the core IPE 136 may deem that it is worth interrupting its current process to receive image data associated with the fill level. By offloading the interrupt handling process to a tunnel controller 115 that is separate from the IPE 136, and by deferring the interruption of the IPE core's process until a threshold is attained, the IPEs 136 and other downstream consumer core processors may more efficiently post-process image data to display to a user, thus reducing latency and enhancing user experience. Furthermore, these context-specific queues and fill-level tracking improves the scalability of the interrupt handling techniques described herein.

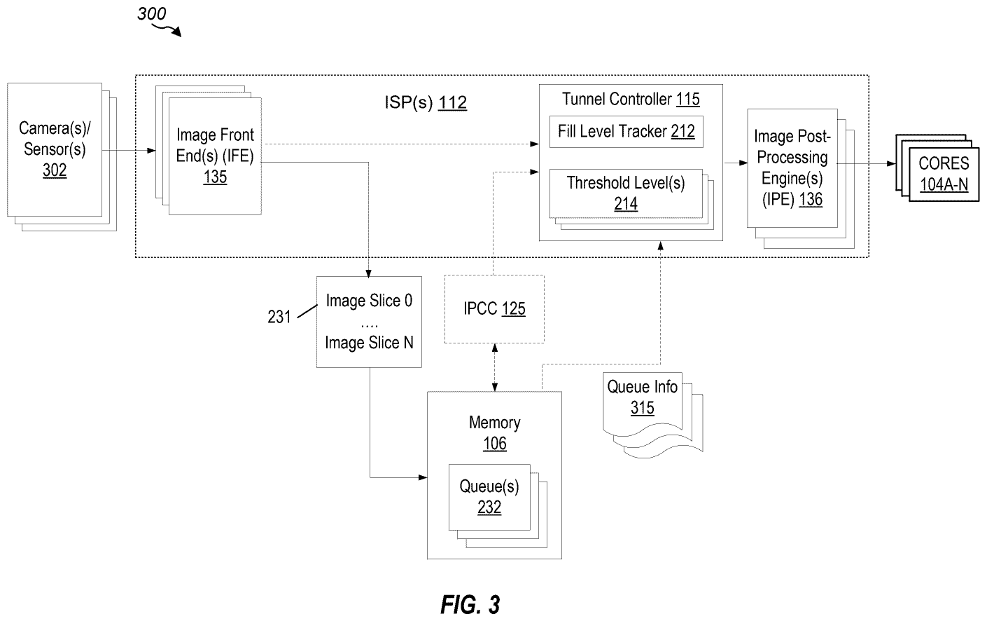

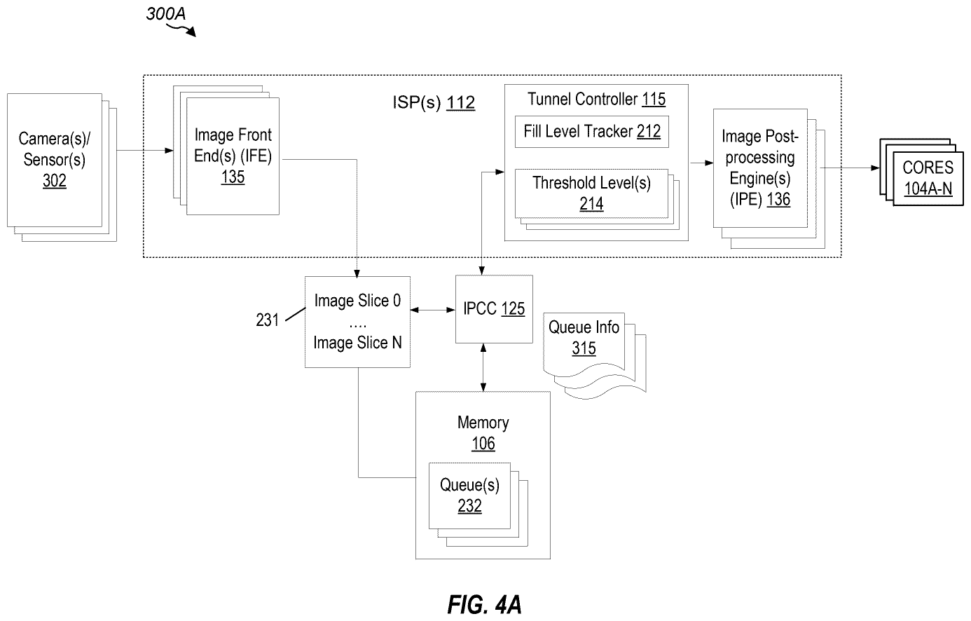

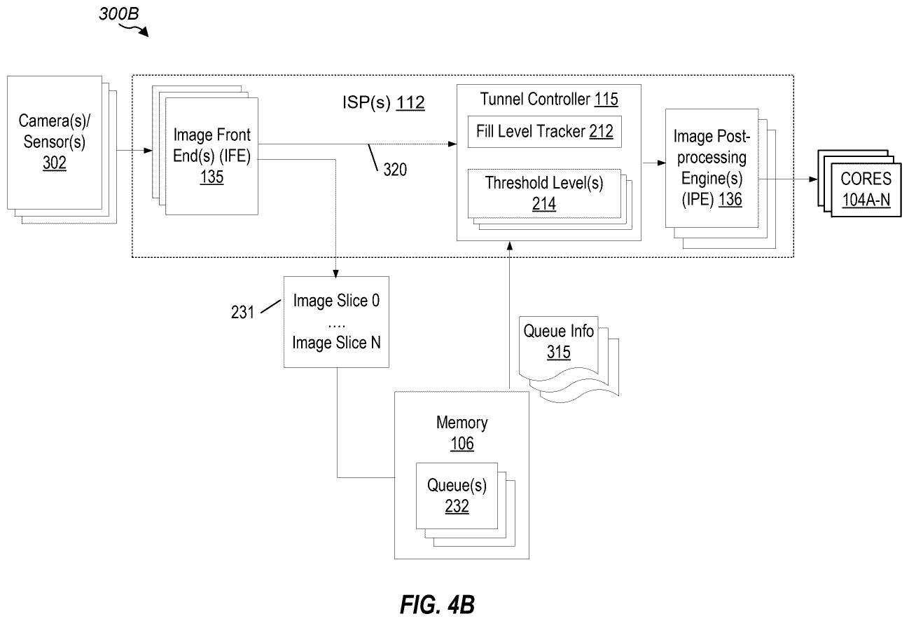

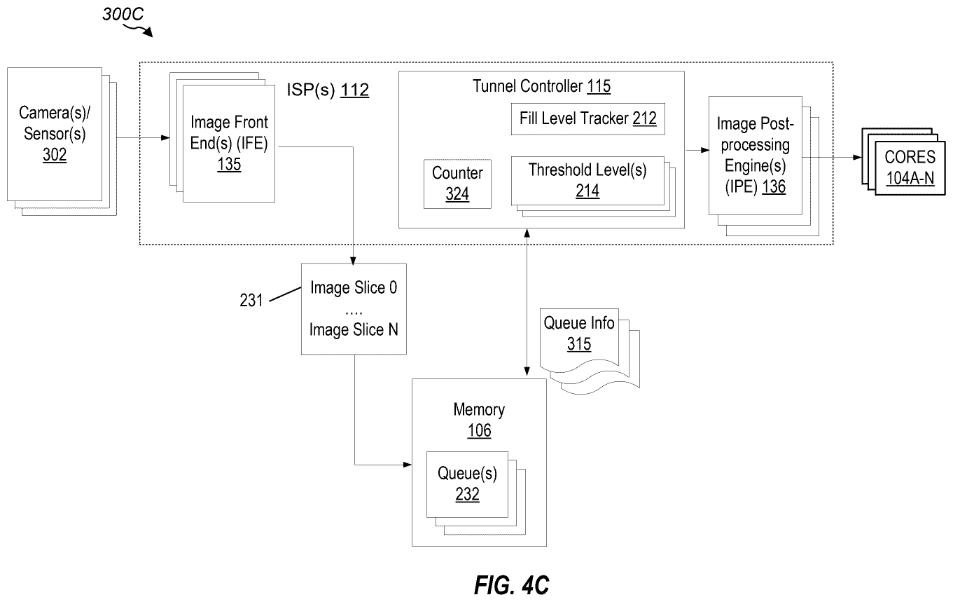

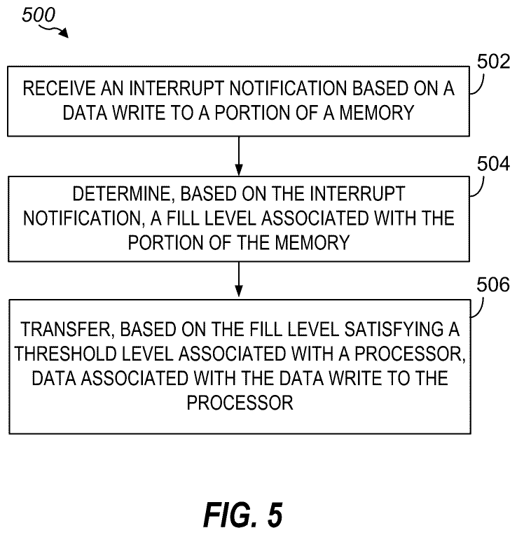

As will be described in more detail herein, the system 200 of FIG. 2 may be configured to perform the operations described with reference to FIG. 5 to perform scalable, low latency interrupt handling. Those operations are described with reference to the systems described in FIG. 3 and FIGS. 4A-4C.

FIG. 3 is a block diagram illustrating an example data flow path for image processing to achieve scalable, low latency interrupt handling according to some embodiments of the disclosure.

As previously discussed, low latency demands and high frames per second (fps) demands in image processing for mixed reality systems (e.g., AR, VR, etc.) necessitate the use of image slicing. For example, by writing image data into the memory 106 by image slices 231, rather than full image frames, ISPs 112 and/or core processors 104A-N need not wait for an entire image frame to be written in order to perform further processing. However, as image slices are processed and written more frequently than image frames, interrupts prompted by the storing of image slices are more frequent than interrupts prompted by the storing of image frames. Handling such increased interrupts may delay the IPEs 136 and other downstream consumer cores from performing their duties efficiently.

FIG. 3 shows an example data flow path 300 that offloads the interrupt handling conventionally handled by the IPEs 136 and other firmware and software of mixed reality devices. For example, one or more cameras and/or sensors 302 (e.g., cameras 103 and 105, sensors 101 or 102) may capture images (e.g., as part of a video, data stream and/or standalone image) and generate image data for processing by the one or more ISP(s) 112. In some embodiments, the image front end(s) (IFEs) 135 (also referred to herein as “front end processor(s)”) may process image data generated by the camera(s)/sensor(s) 302 to output image slices 231 to be written into the memory 106.

The data write of image slices into the memory 106 may cause an interrupt notification to be received by the tunnel controller 115, based on one or more methods described herein (e.g., such as, but not limited to, those described in relation to FIGS. 4A-C). For example, some methods may rely on the IPCC 125 (as will be described in relation to FIG. 4A). In some embodiments, the tunnel controller 115 may receive interrupt notifications by directly interfacing with the IFEs 135 (e.g., as will be described in relation to FIG. 4B). In some embodiments, the tunnel controller 115 may receive an interrupt notification by proactively querying the memory 106 in predefined intervals (e.g., as will be described in relation to FIG. 4C). The tunnel controller 115 may comprise a separate hardware configured to perform interrupt handling based on the output image slice data written into the memory 106, fill level tracking, and facilitate the transfer of the image data (e.g., image slices) to other ISPs 112 (e.g., IPEs 136) and/or other downstream consumer core processors.

The tunnel controller 115 may use the interrupt notification to determine, receive, or otherwise access queue information 315 for a queue 232 in which the image slice 231 pertaining to the interrupt notification is stored. As discussed, the queue information 315 may indicate the number of, size of, or extent of, image slice data 231 stored in an associated queue 232 of the memory 106, the queue 232 may correspond to a given context, such as a given image frame, image data stream, or an image sender or source (e.g., camera and/or sensor 302). The tunnel controller 115 may use the queue information 315 to internally track a fill level associated with the queue 232 (e.g., via an internal fill level tracker 212).

The tunnel controller 115 may be able to facilitate the transfer of the image slices 231 of an image frame, even if the entire image frame is not written, if a fill level associated with a queue 232 pertaining to the image frame satisfies (e.g., exceeds) a threshold 214 associated with an IPE 136 or other downstream consumer core processor. In at least one embodiment, the tunnel controller 115 may have previously received the threshold level(s) 214 to which the fill levels may be compared in order to determine when image slices may be transferred. If, for a given context, the fill level satisfies a threshold level 214, then there may be enough image data pertaining to the context (e.g., image slices 231) accumulated in the queue 232 of the memory 106 (e.g., DDR memory) for an IPE 136 (or other downstream consumer core processor) to kickstart subsequent processing or display of the image slices 231. Hence, the tunnel controller 115 may send or relay the interrupt notification to the IPE 136 (or other downstream consumer core processor) to initiate the subsequent processing. Furthermore, in some embodiments, the tunnel controller 115 may facilitate the transfer of the image slices 231 for subsequent post processing (e.g., by one or more IPEs 318). If, for a given context, the fill level does not satisfy a threshold level, there may not be sufficient image slice data 231 for the context stored yet in the respective queue 232. In such case, the tunnel controller 115 may continue receiving new interrupt notifications and performing fill level tracking (e.g., of the same or of other contexts) until a fill level for a context satisfies a threshold level 214 for an IPE 136 (or other downstream consumer core processor).

FIG. 4A is a block diagram illustrating an example data flow path 300A for image processing to achieve a scalable, low latency mixed reality experience using an inter-processor communications controller (IPCC) or other related system on a chip centralized processor (SOC-CP), according to some embodiments of the disclosure. In particular, FIG. 4A is an implementation of the example data flow path of FIG. 3, in which an IPCC 125 is used to facilitate the receipt of the interrupt notification for the tunnel controller 115.

In at least one embodiment, the example data flow path 300A may include (e.g., initially) the tunnel controller 115 receiving and/or determining the threshold levels associated with the IPEs 136 (or other downstream consumer core processors). The threshold levels 214 may be used for subsequent comparisons with fill levels in the example data flow path 300A.

The example data flow path 300A may further include one or more IFEs 135 outputting image slices 231 to be written into the memory 106. As previously discussed, various ISPs 112, such as the IFEs 135, may generate the image slices 231 after processing image data based on images and/or videos captured by camera(s)/sensor(s) 302. In some embodiments, each IFE 135 may correspond to a separate context. For example, each IFE 135 may be configured to process image data and output image slice data from a corresponding camera and/or sensor 302. The output image slices 231 of a given context (e.g., image frame, image data stream, image source, etc.) may be written into a queue 232 of the memory 106. The queue 232 may comprise a data structure dedicated and/or assigned to store image slices 231 corresponding to the given context. Hence, in some embodiments, the memory 106 may comprise a plurality of queues 232 respectively associated with a plurality of contexts.

In the example data flow path 300A, the IPCC 125 may be notified of the entry of a given image slice 231 into the queue 232. In some embodiments, the IFE 135 may send this notification to the IPCC 125 (e.g., via a bus). Also or alternatively, the IPCC 125 may be notified by detecting or determining the entry of the image slice 231 into the queue 232. Based on the notification, the IPCC 125 may create and/or update a queue information 315 associated with the queue 232. In some embodiments, the queue information 315 may comprise an electronic ledger tracking the number of, size of, or extent of image slice data written (e.g., dumped) into and read (e.g., consumed) from an associated queue 232 of the memory 106, for a given context, such as a given image frame, image data stream, image source (e.g., camera or sensor), etc. In some embodiments, the queue information 315 may also be written into the memory 106. For example, the IPCC 125 may generate and write a token to indicate that a certain image slice is written into the memory 106. The image slice may be identifiable in the token by the sender of the image slice (e.g., an IFE 135) and/or its context (e.g., camera/sensor 302, an image frame or data stream that the image slide is a part of, etc.). Such token may comprise or be a part of an updateable queue information 315 associated with a queue 232.

The example data flow 300A may further include the IPCC 125 delivering an interrupt notification to the tunnel controller 115 based on the updated queue information 315. In some embodiments, prior to the tunnel controller 115 receiving the interrupt notification, the IPCC 125 may render the updated queue information 315 accessible to the tunnel controller 115. For example, the IPCC 125 may copy the queue information 315 into a form accessible to the tunnel controller 115 and then send the copied information as part of, or as a reference within, the interrupt notification. In some embodiments, the interrupt notification may include at least a sender or source of the written image slice data that prompted the IPCC 125 to update the queue information 315.

In some embodiments, each queue 232 may be associated with a first queue information accessible to an IFE 135 and/or a camera/sensor (e.g., the “sender side”) and a second queue information accessible to the tunnel controller 115, IPE 136, and/or another processor downstream from the tunnel controller 115 (e.g., the consumer core).

Also or alternatively, in some embodiments, each queue 232 may be associated with a first queue information accessible to an IFE 135 and/or a camera/sensor (e.g., the “sender side”), and each IPE 136 may be associated with a second queue information for a queue in which the slice image data stored therein may be intended to be processed by the said IPE. In such embodiments, the second queue information may be accessible to the tunnel controller 115 and the IPE 136 or other consumer core. Such differentiation between the first queue information and the second queue information may enable one-to-one, one-to-many, and many-to-one correspondences between contexts (e.g., image sources and/or senders, image data streams, image frames) and IPEs, thereby improving scalability.

The tunnel controller 115 may use the interrupt notification prompted by the data write of the image slice 231 to determine the queue information 315 for the queue 232 in which the written image slice 231 stored in. As previously discussed, the tunnel controller 115 may use the queue information 315 to internally track a fill level associated with the queue 232 (e.g., via the internal fill level tracker 212). If the fill level satisfies a threshold level 214, the tunnel controller 115 may send or relay the interrupt notification to the IPE 136 to initiate subsequent processing of the image slice 231. In some embodiments, the tunnel controller 115 may facilitate the transfer of the image slices 231 for subsequent post processing (e.g., by one or more IPEs 136). If the fill level does not satisfy a threshold level, there may not be sufficient image slice data for the context stored yet in the respective queue 232. In such case, the tunnel controller 115 may continue receiving new interrupt notifications and performing fill level tracking (e.g., of the same or of other contexts) until a fill level for a context satisfies a threshold level 214 for an IPE 136.

It is contemplated that, in some embodiments, the IPCC 125 may miss receiving, or need not receive, a notification of an entry of a given image slice 231 into the queue 232. For example, a given image slice 231 (referred to as “image slice 0” in this example for ease of explanation) may be entered into the queue 232 without a notification being received by the IPCC 125. However, a subsequent image slice (e.g., of the same context as image slice 0) may be entered into the queue 232, and the IPCC 125 may receive a notification of the entry of the subsequent image slice (referred to as “image slice N” in this example for ease of explanation). Moreover, image slice N need not be the consecutively next image slice after image slice 0, as there may be intervening image slices also entered into the queue 232 (e.g., image slices 1 through N−1) after image slice 0 but before image slice N. In this example, even though the IPCC 125 may not have been notified of the entry of one or more previously entered image slices (e.g., image slices 0 to N−1), the IPCC 125 and/or the tunnel controller 115 may be retroactively notified of their entry into the queue 232 based on an updated queue information 315 following the notification of the entry of image slice N. For example, after receiving a notification of the entry of image slice N, the IPCC 125 may access queue information 315 indicating entry of image slice N. The IPCC 125 and/or the tunnel controller 115 may then determine how many image slices were already previously entered into the queue 232 prior to the entry of image slice N by using or accessing a queue counter of the queue 232. The queue counter may be configured to count each image slice as it is entered into the queue 232. Based on the number of image slices, the queue information 315 and the fill level associated with queue 232 may be updated accordingly.

FIG. 4B is a block diagram illustrating an example data flow path 300B for image processing to achieve scalable, low latency interrupt handling (e.g., for an improved mixed reality experience), using a direct link between the image front end (IFE) 135 and the tunnel controller 115, according to some embodiments of the disclosure. In particular, FIG. 4B is an implementation of the example data flow path of FIG. 3, in which direct link between the IFEs 135 and the tunnel controller 115 is used to facilitate the receipt of the interrupt notification for the tunnel controller 115. In some embodiments, example data flow 300B may be used as an alternative to or in addition to the example data flow 300A, as a way to circumvent and/or relieve the processing burden faced by the IPCC 125. In some embodiments (e.g., as shown in FIG. 4B), no IPCC 125 may be needed for the example data flow path 300B.

As shown in FIG. 4B, the tunnel controller 115 directly receives an interrupt notification from the IFEs 135 when any one of the IFEs 135 output an image slice 231 to be written into the memory 106. For example, after or concurrently with outputting the image slice 231 for data write into a queue 232 of the memory 106, the IFE 135 may send the interrupt notification to the tunnel controller 115. The interrupt notification (and any subsequent acknowledgement message) may be transmitted by way of a hardware link 320 (e.g., wired communication) between the tunnel controller 115 and the IFE 135. In some embodiments, each IFE 135 associated with a given context may be communicatively coupled to the tunnel controller 115 via an assigned and/or dedicated hardware link 320. In some embodiments, a hardware link 320 may be shared for interrupt notifications between multiple IFEs 135 (e.g., for multiple respective contexts) and the tunnel controller 115.

The interrupt notification may include an identification of at least a sender, a source, and/or a context of the written image slice data 231. The tunnel controller 115 may use the identification to retrieve the queue information 315 for the queue 232 in which the image slice 231 is written into. As previously discussed, the queue information 315 may indicate the number of, size of, or extent of image slice data written (e.g., dumped) into, and read (e.g., consumed) from, an associated queue 232 in the memory 106. The queue 232, with which the queue information 315 is associated, may pertain to or may be assigned to, a specific context, such as for a specific image frame, image data stream, or image sender or source (e.g., camera or sensor).

As previously discussed, the tunnel controller 115 may use the queue information 315 to internally track a fill level associated with the queue 232 (e.g., via the internal fill level tracker 212). If the fill level satisfies a threshold level 214, the tunnel controller 115 may send or relay the interrupt notification to the IPE 136 (or other downstream consumer core processor) to initiate subsequent processing of the image slice 231. In some embodiments, the tunnel controller 115 may facilitate the transfer of the image slices 231 for subsequent post processing (e.g., by one or more IPEs 136). If the fill level does not satisfy a threshold level 214, there may not be sufficient image slice data 231 for the context stored yet in the respective queue 232. In such case, the tunnel controller 115 may continue receiving new interrupt notifications and performing fill level tracking (e.g., of the same or of other contexts) until a fill level for a context satisfies a threshold level 214 for an IPE 136 (or other downstream consumer core processor).

It is contemplated that, in some embodiments, the tunnel controller 115 may miss receiving, or need not receive, an interrupt notification when an image slice 231 is written into the memory 106. For example, a given image slice 231 (referred to as “image slice 0” in this example for ease of explanation) may be entered into the queue 232 without a subsequent interrupt notification being received by the tunnel controller. However, a subsequent image slice (e.g., of the same context as the previously entered image slice 0) may be entered into the queue 232. The subsequent image slice (referred to as “image slice N” in this example for ease of explanation) need not be the consecutively next image slice after image slice 0, as there may be intervening image slices entered into the queue 232 (image slices 1 through N−1) after image slice 0 but before image slice N. The tunnel controller 115 may receive notification of the entry of image slice N even if the tunnel controller 115 may not have received an interrupt notification earlier based on the entry of one or more previously entered image slices in the queue 232. However, the queue information 315 accessed via the interrupt notification received for image slice N may indicate the entry of the one or more previously entered image slices (e.g., image slice 0) in the queue 232. For example, based on the queue information 315 indicating entry of image slice N, the tunnel controller 115 may determine how many image slices were already previously entered into the queue 232 using a queue counter. The queue information 315 may be updated to reflect entry of the previously entered image slices 0 through N−1. Based on the number of image slices, the tunnel controller 115 may update the fill level associated with queue 232 accordingly.

FIG. 4C is a block diagram illustrating an example data flow path 300C for image processing to achieve scalable, low latency interrupt handling (e.g., for improved mixed reality experience) using interval-based interrupt handling, according to some embodiments of the disclosure. In particular, FIG. 4C is an implementation of the example data flow path of FIG. 3, in which the tunnel controller 115 receives interrupt notifications by proactively querying the memory 106 at predefined intervals. The implementation shown in FIG. 4C obviates the need for, and the burden placed on, the IPCC 125 (e.g., of example data flow 300A). Furthermore, the implementation shown in FIG. 4C provides for more scalability by obviating the need for hardware links to be established between IFEs 135 and the tunnel controller 115. Thus, additional camera(s)/sensor(s) 302, IFEs 135, and other ISP(s) 112 may be added without the need to establish hardware links between said components and the tunnel controller 115.

As shown in FIG. 4C, the example data flow path 300C may include the tunnel controller 115 sending periodic queries to the memory 106 to fetch queue information 315. In some embodiments, the periodic queries may be based on predefined intervals. The intervals may be measured and/or tracked via a counter 324 (e.g., a local or global clock). Also or alternatively, the periodic queries may determine whether there are any updates to the queue information 315 pertaining to one or more queues 232 of the memory 106.

As previously discussed, an update to a queue information 315 may be triggered based on the entry (e.g., data write) or access (e.g., data read) of an image slice 231 into a queue 232 associated with the queue information 315. In some implementations, such as the implementation shown in FIG. 4C, the update may be performed by the ISPs 112 (e.g., IFE 135) or the memory 106 itself. If there was an update within the predefined interval preceding the query, the tunnel controller 115 may receive, in response to the query, the interrupt notification. The interrupt notification may thus indicate an update to a queue information 315 of a queue 232. For example, the interrupt notification may provide an identification of a sender, source, or other context associated with the image slice 231 that was written into the queue 232 during the preceding predefined interval.

The tunnel controller 115 may use such information from the interrupt notification to access the queue information 315 associated with the updated queue 232. From thereon, the tunnel controller 115 may use the queue information 315 to internally track a fill level associated with the queue 232 (e.g., via the internal fill level tracker 212). If the fill level satisfies a threshold level 214, the tunnel controller 115 may send or relay the interrupt notification to the IPE 136 (or other downstream consumer core processor) to initiate subsequent processing of the image slice 231. In some embodiments, the tunnel controller 115 may facilitate the transfer of the image slices 231 for subsequent post processing (e.g., by one or more IPEs 136). If the fill level does not satisfy a threshold level, there may not be sufficient image slice data for the context stored yet in the respective queue. In such case, the tunnel controller 115 may continue receiving new interrupt notifications and performing fill level tracking (e.g., of the same or of other contexts) until a fill level for a context satisfies a threshold level 214 for an IPE 136 (or other downstream consumer core processor).

FIG. 5 shows a flow chart of an example method 500 for processing image data to perform a scalable latency reduction in a mixed reality system, according to some embodiments of the disclosure. Various operations described with reference to FIG. 4 may be performed by the tunnel controller 115, in combination with one or more ISPs 112 (e.g., IFEs 135, IPEs 136 or other downstream core processors, etc.) and/or one or more processors 104 (e.g., IPCC 125).

At block 502, an interrupt notification is received based on a data write to a portion of a memory. For example, the portion may be a queue 232 or other data structure in the memory 106, and the interrupt notification may be based on the entry of data such as, but not limited to, an image slice 231 (or other chunk of an image data) into the queue 232. The image slice 231 may be stored in queue (or other related data structure) of the memory 106, where said queue is assigned to or otherwise associated with a context of the image slice 231. The context may refer to the larger image frame, image data stream, image source and/or image sender, with which the image slice is a part of or associated with.

In some embodiments, the tunnel controller 115 may receive the interrupt notification from a second controller (e.g., the IPCC 125), which may be configured to access the memory. The interrupt notification may enable the tunnel controller 115 to determine a queue information 315 for a queue 232 (e.g., a portion of the memory) in which the data write occurred. For example, determining the queue information 315 may involve identifying, using the interrupt notification, a sender of the data associated with the data write (e.g., the source of the image slice 231). Also or alternatively, the tunnel controller 115 may identify, using the interrupt notification, another context for the data (e.g., image frame, image data stream, etc.). Based on the sender (or other context), the tunnel controller 115 may determine a memory location for the data associated with the data write (e.g., a position of the image slice within a queue or other portion of the memory). The queue information may be determined using the memory location.

Also or alternatively, the interrupt notification may be directly received from a front end processor (e.g., IFE 135) configured to generate the data associated with the data write (such as but not limited to image slice 231).

Also or alternatively, the interrupt notification may be received based on the tunnel controller 115 determining a fill level associated with the portion of the memory 106 at predefined intervals. For example, the tunnel controller 115 may query the memory 106 at the predefined intervals to determine if there is any update to the queue information 315 pertaining to a queue 232 in the memory 106. If there is an update, the memory 106 may respond accordingly with the interrupt notification. In some aspects, the interrupt notification may include or indicate a context behind the data write leading to the update in the queue information. The updated queue information 315 may be used by the tunnel controller 115 to determine the fill level for the queue 232.

Non-limiting examples of techniques and processes by which the tunnel controller 115 may receive the interrupt notification are further discussed herein in relation FIGS. 4A-4C.

The image data, from which the images slices 231 are generated (e.g., by IFEs 135), may be received, for example, from a bus coupled to the first camera 103 or from an analog front end (AFE) coupled to the first camera 103. The first image data may alternatively be received from a wireless camera, in which the image data is received through one or more of the WAN adaptor 152, the LAN adaptor 153, and/or the PAN adaptor 154. The first image data may alternatively be received from a memory location or a network storage location. For example, in at least one embodiment, image data that was previously captured may now retrieved from memory 106 and/or a remote location through one or more of the WAN adaptor 152, the LAN adaptor 153, and/or the PAN adaptor 154, before being sliced into image slices (e.g., by IFEs 135) to be stored back in the memory 106. In some embodiments, the capture of image data may be initiated by a camera application executing on the processor 104, which causes camera control 210 to activate capture of image data by the first camera 103.

At block 504, based on the interrupt notification, a fill level associated with the portion of the memory 106 may be determined. The portion of the memory 106 may be the queue 232 in which data comprising the image slice 231 was written into. The fill level may thus be determined using the queue information 315 associated with the queue 232. For example, the tunnel controller 115 may use the interrupt notification to access the queue information 315 for the queue 232 storing the image slice 231 associated with the interrupt notification. In some aspects, the interrupt notification may provide an identification of the sender, source, or other context of the image slice. The tunnel controller 115 may use the identification to access the queue information 315. The queue information 315 may indicate the number of, size of, or extent of image slice data 231 written (e.g., dumped) into, and read (e.g., consumed) from, an associated queue 232 in the memory 106. The queue 232, with which the queue information 315 is associated, may pertain or be assigned to a specific context, such as for a specific image frame, image data stream, or image sender or source (e.g., camera and/or sensor 302).

The tunnel controller 115 may use the queue information 315 to determine the fill level For example, the tunnel controller 115 may update a fill level tracker 212 associated with the queue or other portion of the memory 106. The fill level tracker 212 may be a software module, program, or code configured to internally tracks a fill level associated with the a queue 232 or other portion of the memory 106. In some embodiments, a fill level may indicate the extent to which image slices 231 pertaining to a given context (e.g., a given image frame, image data stream, image source or sender) is completed. Also or alternatively, the fill level may indicate the capacity utilization of the queue 232 based on the current image slices stored.

At block 506, based on the fill level satisfying a threshold level associated with a processor (e.g., IPE 136), data associated with the data write (e.g., image slice 231) may be transferred to the processor (e.g., IPE 136). In various embodiments, the processor may correspond to IPE 136 or other processor downstream of the IFE 135 in the image processing pipeline. Furthermore, the data associated with the data write may comprise an image slice 231. For example, the tunnel controller 115 may compare the fill level associated with a portion of the memory (e.g., a queue 232) with the threshold level associated with the IPE 136 (or other downstream consumer core processor). In some embodiments, the threshold level (e.g., threshold level(s) 214) associated with the processor (e.g., IPE 136) may be previously received or previously determined by the tunnel controller 115 for the subsequent aforementioned comparison.

In some embodiments, each portion (e.g., queue) may be assigned to store image slices for a specific context (e.g., an image frame, image data stream, a sender or source of the image slice, etc.). If the fill level for a specific portion satisfies the threshold level, the processor (e.g., IPE 136) to which the data may get transferred to may be assigned to process image slices pertaining to that specific context. In some embodiments, multiple queues of the memory may be assigned to a specific context. Alternatively, a queue may be associated with multiple contexts. In some embodiments, multiple IPEs 136 or multiple other downstream consumer core processors may process image slices pertaining to the same context. Alternatively, a single IPE 136 (or a single downstream consumer core processor) may process image slices pertaining to multiple contexts.

It is also contemplated that a fill level associated with another portion of the memory (e.g., a second portion or a second queue) may not necessarily satisfy the threshold level associated with said processor (e.g., IPE 136). In such embodiments, the tunnel controller 115 may prevent or defer the transfer of data associated with the data write to such processor.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to image processing to achieve scalable, low latency interrupt handling. The apparatus is further configured to: receive an interrupt notification based on a data write into a portion of the memory; determine, based on the interrupt notification, a fill level associated with the portion of the memory; and transfer, based on the fill level satisfying a threshold level associated with a second processor, data associated with the data write to the second processor.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus. In some implementations, an image capture device is disclosed, which comprises: a camera configured to capture an image; a front end processor configured to generate a plurality of slices of image data from the image; an image post-processing engine (IPE) configured to perform image processing on the plurality of slices of image data; a memory configured to store the plurality of slices of image data; and a controller coupled to the memory and configured to perform one or more operations described herein with reference to the apparatus.

In a second aspect, in combination with the first aspect, the at least one processor of the apparatus is further configured to determine the fill level associated with the portion of the memory by: determining, based on the interrupt notification, the fill level and a queue information for the data, wherein the fill level is determined using the queue information.

In a third aspect, in combination with one or more of the first aspect or the second aspect, the at least one processor of the apparatus is further configured to: receive the interrupt notification from a second controller configured for accessing the memory.

In a fourth aspect, in combination with one or more of the first aspect through the third aspect, the at least one processor of the apparatus is further configured to: determine the queue information by: identifying, based on the interrupt notification, a sender of data associated with the data write; and determining, based on the sender, a memory location for the data associated with the data write, wherein the queue information is determined using the memory location.

In a fifth aspect, in combination with one or more of the first aspect through the fourth aspect, the at least one processor of the apparatus is further configured to: directly receive the interrupt notification from a front end processor configured to generate the data associated with the data write.

In a sixth aspect, in combination with one or more of the first aspect through the fifth aspect, the fill level associated with the portion of the memory is determined at predefined intervals.

In a seventh aspect, in combination with one or more of the first aspect through the sixth aspect, the at least one processor of the apparatus is configured to perform operations further comprising: receiving, by the at least one processor, a second interrupt notification based on a second data write into a second portion of the memory; determining, by the at least one processor and based on the second interrupt notification, a second fill level associated with the second portion of the memory; and deferring, by the at least one processor and based on the second fill level for the second portion of the memory not satisfying the threshold level associated with the second processor, transfer of second data associated with the second data write to the second processor.

In an eighth aspect, in combination with one or more of the first aspect through the seventh aspect, the data is a slice of image data, and wherein the interrupt notification indicates writing of the slice of image data for processing by an image post-processing engine (IPE).

In a ninth aspect, in combination with one or more of the first aspect through the eighth aspect, the IPE comprises the second processor, wherein the at least one processor is configured to transfer the data by: sending, based on the fill level satisfying the threshold level, the interrupt notification to the IPE to process the slice of image data.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Although embodiments are described as relating to image data, image slices, or image frames, it is contemplated that embodiments described herein may also be applicable to data pertaining to other data types (e.g., audio data, video data, musical instrument digital interface (MIDI) data, etc.). For example, in some embodiments, an interrupt notification may be based on a data write of a slice of audio data into a queue of the memory. In such embodiments, queue information for the slice of audio data and a fill level associated with the queue of the memory may be determined. Furthermore, the interrupt notification may be sent to an audio processing engine to process the slice of data, based on the fill level satisfying a threshold level associated with the audio post-processing engine.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will understand that one or more blocks (or operations) described with reference to FIG. 5 may be combined with one or more blocks (or operations) described with reference to another of the figures. For example, one or more blocks (or operations) of FIG. 5 may be combined with one or more blocks (or operations) of FIGS. 1-3 and 4A-4C.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving, by a controller, an interrupt notification based on a data write into a portion of a memory;
determining, by the controller and based on the interrupt notification, a fill level associated with the portion of the memory; and
transferring, by the controller and based on the fill level satisfying a threshold level associated with a processor, data associated with the data write to the processor.

2. The method of claim 1, wherein determining the fill level associated with the portion of the memory comprises:
determining, by the controller and based on the interrupt notification, the fill level and a queue information for the data, wherein the fill level is determined using the queue information.

3. The method of claim 2, wherein the interrupt notification is received from a second controller configured to access the memory, wherein determining the queue information comprises:
identifying, based on the interrupt notification, a sender of data associated with the data write; and
determining, based on the sender, a memory location for the data associated with the data write, wherein the queue information is determined using the memory location.

4. The method of claim 1, wherein the interrupt notification is directly received from a front end processor configured to generate the data associated with the data write.

5. The method of claim 1, wherein the fill level associated with the memory is determined at predefined intervals.

6. The method of claim 1, further comprising:
receiving, by the controller, a second interrupt notification based on a second data write into a second portion of the memory;
determining, by the controller and based on the second interrupt notification, a second fill level associated with the second portion of the memory; and
deferring, by the controller and based on the second fill level for the second portion of the memory not satisfying the threshold level associated with the processor, transfer of second data associated with the second data write to the processor.

7. The method of claim 1, wherein the data is a slice of image data, and wherein the interrupt notification indicates writing of the slice of image data for processing by the processor comprising an image post-processing engine (IPE).

8. The method of claim 7, wherein the processor is the IPE, wherein transferring the data comprises:
sending, by the controller and based on the fill level satisfying the threshold level, the interrupt notification to the IPE to process the slice of image data.

9. An apparatus, comprising:
a memory configured to store data; and
at least one processor coupled to the memory and configured to perform operations comprising:
receiving an interrupt notification based on a data write into a portion of the memory;
determining, based on the interrupt notification, a fill level associated with the portion of the memory; and
transferring, based on the fill level satisfying a threshold level associated with a second processor, data associated with the data write to the second processor.

10. The apparatus of claim 9, wherein the processor is configured to determine the fill level associated with the portion of the memory by:
determining, based on the interrupt notification, the fill level and a queue information for the data, wherein the fill level is determined using the queue information.

11. The apparatus of claim 10, wherein the at least one processor is configured to receive the interrupt notification from a second controller configured for accessing the memory.

12. The apparatus of claim 11, wherein the at least one processor is configured to determine the queue information by:
identifying, based on the interrupt notification, a sender of data associated with the data write; and
determining, based on the sender, a memory location for the data associated with the data write, wherein the queue information is determined using the memory location.

13. The apparatus of claim 9, wherein the at least one processor is configured to directly receive the interrupt notification from a front end processor configured to generate the data associated with the data write.

14. The apparatus of claim 9, wherein the fill level associated with the portion of the memory is determined at predefined intervals.

15. The apparatus of claim 9, wherein the at least one processor is configured to perform operations further comprising:
receiving, by the at least one processor, a second interrupt notification based on a second data write into a second portion of the memory;
determining, by the at least one processor and based on the second interrupt notification, a second fill level associated with the second portion of the memory; and
deferring, by the at least one processor and based on the second fill level for the second portion of the memory not satisfying the threshold level associated with the second processor, transfer of second data associated with the second data write to the second processor.

16. The apparatus of claim 9, wherein the data is a slice of image data, and wherein the interrupt notification indicates writing of the slice of image data for processing by an image post-processing engine (IPE).

17. The apparatus of claim 16, wherein the IPE comprises the second processor, wherein the at least one processor is configured to transfer the data by:
sending, based on the fill level satisfying the threshold level, the interrupt notification to the IPE to process the slice of image data.

18. An image capture device, comprising:
a camera configured to capture an image;
a front end processor configured to generate a plurality of slices of image data from the image;
an image post-processing engine (IPE) configured to perform image processing on the plurality of slices of image data;
a memory configured to store the plurality of slices of image data; and
a controller coupled to the memory and configured to perform operations comprising:
receiving an interrupt notification based on a data write of a slice of data into a queue of the memory;
determining, based on the interrupt notification, queue information for the slice of data and a fill level associated with the queue of the memory, wherein fill level is determined using the queue information;
sending, based on the fill level satisfying a threshold level associated with the image post-processing engine (IPE), the interrupt notification to the IPE to process the slice of image data; and
transferring the slice of data to the IPE.

19. The image capture device of claim 18, wherein the controller is configured to determine the queue information by:
identifying, based on the interrupt notification, a sender of data associated with the data write; and
determining, based on the sender, a memory location for the data associated with the data write, wherein the queue information is determined using the memory location.

20. The image capture device of claim 18, wherein the controller is configured to determine the fill level at predefined intervals.
